(19) United States
(12) Patent Application Publication
(10) Pub. No.: US 2007/0258504 A1
(43) Pub. Date: Nov. 8, 2007

(54) Means And Method For Monitoring The Assembly Of Threaded Components

(75) Inventor: Fritz Enderweit, Kardinya (AU)

Correspondence Address: ROTHWELL, FIGG, ERNST & MANBECK, P.C., 1425 K STREET, N.W., SUITE 800, WASHINGTON, DC, 20005, US

(73) Assignee: THERMTECH PTY LTD., BIBRA LAKE (AU)

(21) Appl. No.: 10/564,197

(22) PCT Filed: Jul. 12, 2004
(86) PCT No.: PCT/AU04/00940

§ 371 Date: Oct. 24, 2006

(30) Foreign Application Priority Data
Jul. 11, 2003 (AU) 2003903593

(51) Int. Cl. G01K 13/08

(52) U.S. Cl. 374/46; 374/100

(57) ABSTRACT

An apparatus and method for monitoring the assembly of threaded components including a station (13) at which two threaded components are to be threadably interengaged, a heat sensor (11) located at the station and positioned to sense the temperatures of the threaded coupling (15) whilst being threadably engaged or disengaged, an output associated with the sensor which is adapted to display (17) an indication of the temperatures of the coupling (15) during assembly or disassembly of the components.

### CROSS-REFERENCE TO RELATED APPLICATION

This application is a National Phase of International Application Ser. No. PCT/AU2004/000940, filed Jul. 12, 2004.

### BACKGROUND OF THE INVENTION

1. Field of the Invention

This invention relates to means for monitoring and method of monitoring the assembly of threaded components.

2. Description of the Background Art

In the assembly of threaded components it is usual that once the threaded components are interengaged that they be readily capable of being disconnected at some time in the future. In general mechanical applications this does not necessarily represent a difficulty, due to the significant degree of tolerance provided between interengaging surfaces of the threaded interconnection. However in specialised applications such as in the drilling industry and drilling technology the threaded interconnection between items which are generally known in the industry as “oil country tubular goods” involves the use of specialised threads which can be of a very precise profile and which have very close tolerance. Whilst it is necessary that the threaded interconnection have a very high integrity once made it is also essential that the threaded components be capable of being disengaged when it becomes necessary to modify or extract a drill string within accepted limits. In the case of such goods it has been known that because of an incompatibility in the nature of the materials of the two interengaging surfaces and/or incompatibility between the threaded formations on each component and/or damage to one or both threads and/or differing tolerances between the threads and/or detritus between the threaded formations, that during the threaded interengagement of the two threaded components the appropriate amount of torque will be applied in effecting the interconnection, a much greater degree of torque must be applied to effect the disconnection. This greater amount of torque can result in damage to the component if not to the threads of the components and can cause disruption at the site. In addition it has been found that that only a small amount of intolerance between threads and/or damage and/or detritus needs to be introduced between the threaded formations in order to result in the jamming of the threaded interconnection.

The prior art methods of monitoring the threaded engagement between two components has comprised monitoring the magnitude of the torque that is applied whilst effecting the threaded engagement. Whist this procedure has been found to be effective in many cases it lacks the sensitivity to draw attention to faults which do not significantly affect magnitude of the torque being applied during the process of engagement but present a significant problem in the disengagement.

### SUMMARY OF THE INVENTION

Accordingly the invention resides in a means for monitoring the assembly of threaded components comprising a station at which two threaded components are to be threadably interengaged, a heat sensor adapted to sense infra red radiation, the sensor located and positioned at the station to sense the temperatures over the inter-engaged surfaces of the threaded coupling whilst being threadably engaged or disengaged, an output associated with the sensor which is adapt to display an indication of the variations of the temperatures of the inter-engaged surfaces of the coupling during assembly or disassembly of the components.

According to a preferred feature of the invention the output comprises a display. According to a preferred feature of the invention the display comprises a pictorial representation of the coupling which indicates the temperatures of the inter-engaged surfaces of the coupling being monitored. According to a preferred feature of the invention the sensor comprises an infrared camera.

According to a preferred feature of the invention a plurality of sensors are located at the station, said sensors being angularly displaced around the coupling during assembly or disassembly to scan the full outer surface of the coupling. According to one embodiment the display comprises a single image which is representative of the full surface area of the coupling and which is representative of the full surface area of the coupling and which is a composite of the output of each of the sensors.

According to another aspect the invention resides in a method of monitoring the assembly of threaded components comprising sensing the variation in temperatures of the inter-engaged surfaces of the threaded coupling whilst being threadably engaged or disengaged and monitoring the temperature of the coupling for the occurrence of zones which are the subject of an increased temperature when compared to the remainder of the threaded coupling.

According to preferred feature of the invention the method comprises the use of a monitoring means described above.

The invention will be more fully understood in the light of the following of several specific embodiments.

### BRIEF DESCRIPTION OF THE DRAWINGS

The description is made with reference to the accompanying drawing which is a schematic representation of the monitoring means according to the first embodiment.

### DETAILED DESCRIPTION OF PREFERRED EMBODIMENTS

The first embodiment is directed to means for monitoring the assembly of threaded coupling and has particular application to threaded couplings which are used for interconnecting tubing and casing string components. It is general practice that these components are assembled under factory conditions into units which can then be taken to a drill site and applied to a drill string as they are required. The threads which are used to threadably interconnect such components are generally of a very precise profile and are manufactured to very close tolerances. Furthermore once installed the threaded components must be capable of being readily uncoupled to enable them to be extracted from a drill string for use on another occasion as required. Therefore whilst the threaded connection must be sound during use it must be readily capable of being disconnected whereby during such disconnection the components to either side of the threaded junction are not damaged.

It has been found that only a minor degree of damage to one or both threads can incur irreparable damage to the mating threaded component during assembly of the component which subsequently prevents the couplings from being disconnected within acceptable limits. Such damage can also arise where one thread has been formed at the end of a production run of a die and the mating thread has been formed at the commencement of the production run of the die resulting in a disparity between the threads which can result in undue binding forces being applied to the threads on assembly.

Currently there is no means of accurately determining the creation of damage to an interconnection when threaded components are being interengaged other than maintaining a very close location on the degree of torque that is applied to the threaded coupling at any particular time. In addition the presence of such faults often do not become readily apparent if one merely monitors the torque being applied to the coupling during the connection process.

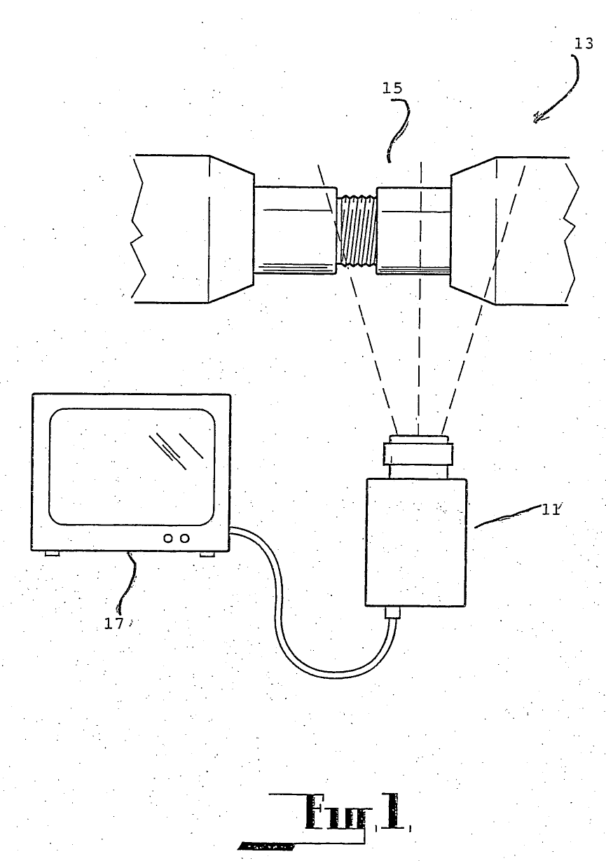

The first embodiment comprises infrared camera 11 which is positioned beside a coupling station 13 as shown at FIG. 1 where the lens of the camera is directed at the coupling 15 during assembly such that the whole of the face opposite the lens coupling is observed by the camera. The camera has an output which comprises a display 17 associated which is able to provide a pictorial representation of the temperatures of the coupling where the display is coloured and the various colours are representative of the temperatures of the coupling where the calibration is such that a minor temperature variation between comes quite apparent.

Whilst the threaded connection is being effected the display associated with the camera is monitored in order to determine the occurrence of “shot spots” or areas of increased temperature that may induced into the coupling during the assembly. If the display indicates an unexpected heat increase in the coupling as a whole or at any one location or at a region, this may be taken as an indication to the operator that there is an incompatibility between the threads or a like unsatisfactory situation which will require the threaded elements to be disconnected and inspected to determine the cause of the increased frictional engagement between the threads which has resulted in the temperature increase.

It is envisaged that the embodiment can be utilised under factory-like conditions and/or in-situ or in drill rigs or like situations where threaded couplings are being interengaged.

As a result of testing it has been found that by merely introducing a minor fault in one thread the use of the first embodiment has been able to sense the very first binding of the treaded coupling as a result of that fault before is sensed by monitoring the torque being applied to the components. The presence of the fault became apparent by the presence of a “shot spot on the threaded formation carrying the fault very shortly it came into face to face engagement with the threaded formation of the other component.

According to a second embodiment a number of cameras are located around the coupling such that the full surface area of the coupling is being scanned and the output of each of the cameras is combined to provide a single display representative of the full surface area of the coupling.

According to a third embodiment of the invention the camera is hand held and is used in situ on drill rigs and like situations to monitor the coupling of fresh lengths of pipe into a drill string, to ensure that the coupling is sound and is not subjected to adverse conditions that may result in failure or a jamming of the coupling. In the case of gas and oil rigs this will require the camera to be housed such that it does not present a hazard.

Throughout the specification, unless the context requires otherwise, the word “comprise” or variations such as “comprises” or “comprising”, will be understood to imply the inclusion of a stated integer or group of integers but not the exclusion of any other integer or group of integers.

It should be appreciated that the scope of the present invention need not be limited to the particular scope of the embodiment described above. In particular whilst the embodiments have been directed to use with couplings which are used in drill rigs the invention has application to any circumstance where the coupling of threaded interconnections need to be monitored.

1. A means for monitoring the assembly of threaded components comprising a station at which two threaded components are to be threadably interengaged, a heat sensor located at the station and positioned to sense the temperatures of the threaded coupling whilst being threadably engaged or disengaged, an output associated with the sensor which is adapted to display an indication of the temperatures of the coupling during assembly or disassembly of the components.

2. A means as claimed at claim 1 wherein the output comprises a display.

3. A means as claimed at claim 2 wherein the display comprises a pictorial representation of the coupling which indicates the temperatures of the coupling being monitored.

4. A means as claimed at claim 1, wherein the sensor comprises an infrared camera.

5. A means as claimed at claim 1, wherein a plurality of sensors are located at the station, said sensors being angularly displaced around the coupling during assembly or disassembly to scan the full outer surface of the coupling.

6. A means as claimed at claim 5 wherein the display comprises a single image which is representative of the full surface area of the coupling and which is a composite of the output of each of the sensors.

7. A method of monitoring the assembly of threaded components comprising sensing the temperature of the threaded coupling whilst being threadably engaged or disengaged and monitoring the temperature of the coupling for the occurrence of zones which are the subject of an increased temperature when compared to the remainder of the threaded coupling.

8. A method as claimed at claim 7 wherein the method comprises use of an infra-red camera as the sensing means and the display provides a coloured representation of the coupling where the change in colouring is representative of the temperatures of the coupling.

9. A method as claimed at claim 7 wherein a plurality of sensors are located at angularly disposed positions around the coupling.

10. A method for monitoring the assembly of threaded components substantially as herein described.

11. A means for monitoring the assembly of threaded components substantially as herein described.
